(19) United States
(12) Patent Application Publication
(10) Pub. No.: US 2015/0290576 A1
(43) Pub. Date: Oct. 15, 2015

(54) BIPOLAR ELECTRODIALYZER AND PURIFICATION METHOD FOR AMINE FLUID USING SAME

(71) Applicant: ASAHI KASEI KABUSHIKI KAISHA, Tokyo (JP)

(72) Inventors: Akira Kiguchi, Tokyo (JP); Norikazu Fujimoto, Tokyo (JP)

(73) Assignee: ASAHI KASEI KABUSHIKI KAISHA, Tokyo (JP)

(21) Appl. No.: 14/442,900

(22) PCT Filed: Nov. 15, 2013
(86) PCT No.: PCT/JP2013/080946

§ 371 Date: May 14, 2015

(30) Foreign Application Priority Data
Nov. 16, 2012 (JP) 2012-252329

(51) Int. Cl. B01D 53/14; B01D 61/54; B01D 61/44

(52) U.S. Cl. CPC B01D 53/1425; B01D 61/445; B01D 61/54; B01D 53/1475; B01D 2311/18; B01D 2252/204

(57) ABSTRACT

Provided is an electrodialyzer for regenerating amines, comprising a negative electrode, a positive electrode, a bipolar film, and an anion exchange film. The electrodialyzer includes a chamber having an amine purification function, a chamber having an amine recovery function, and a chamber having an acid recovery function, between the facing negative electrode and positive electrode and in order in the direction from the negative electrode towards the positive electrode. The chamber having the amine purification function is surrounded by the bipolar film arranged on the negative electrode side and the anion exchange film arranged at a position facing the bipolar film. The chamber having the amine recovery function is surrounded by a set of facing anion exchange films, and the chamber having an acid recovery function is surrounded by the anion exchange film arranged on the negative electrode side, and the positive electrode or bipolar film arranged at a position facing the anion exchange film.

### TECHNICAL FIELD

The present invention relates to a bipolar electrodialyzer and a method for purifying an amine solution by using the same.

### BACKGROUND ART

In recent years, a greenhouse effect of CO₂ has been indicated as one of causes for the global warming phenomenon, and measures thereagainst have been internationally imperative so as to protect the global environment. The source of CO₂ generation includes all fields of human activity involving fossil fuel burning, and the demand for suppressing of emissions is increasing. Accompanying this trend, a method of contacting a combustion flue gas in a boiler with an amine-based CO₂ absorbing solution to remove and recover CO₂ in the combustion flue gas, and a method of storing the recovered CO₂ without releasing it into the atmosphere are being studied by targeting power generation facilities, such as a thermoelectric power plant using a large amount of fossil fuel.

The process employed for removing/recovering CO₂ from a combustion flue gas by using the above-described CO₂ absorbing solution includes a process of contacting a combustion flue gas with the CO₂ absorbing solution in an absorption column, and a process where the absorbing solution which has absorbed CO₂ is heated in a regeneration column to liberate CO₂ and regenerate the absorbing solution and the regenerated absorbing solution is again circulated to the absorption column, and is reused.

In the conventional CO₂ recovery apparatus, for example, a CO₂-containing flue gas discharged from an industrial facility, such as a boiler, is cooled with cooling water in a cooling column, and the cooled CO₂-containing flue gas is brought into countercurrent contact with an alkanolamine-based CO₂ absorbing solution in an absorption column to let CO₂ in the flue gas be absorbed by the CO₂ absorbing solution and thereby remove CO₂ from the flue gas. The CO₂ absorbing solution having absorbed therein CO₂ (i.e., rich solution) releases CO₂ in a regeneration column, and most of CO₂ is removed until reaching the bottom of the regeneration column, whereby the CO₂ absorbing solution is regenerated as a solution with a low CO₂ content percentage (i.e., lean solution). The regenerated CO₂ absorbing solution is again fed to the absorption column, and is reused.

In such a combustion flue gas, carbonyl sulfide, hydrogen cyanide, formic acid, acetic acid, oxalic acid, thiocyanic acid, thiosulfuric acid, and other inorganic acids, in addition to SOₓ or NOₓ remaining without being removed in the desulfurization/denitration step, are contained, and in the de-CO₂ step, react with an alkanolamine contained in the CO₂ absorbing solution to produce a heat-stable salt. In addition, amine degradation due to heat or oxygen at the time of recovering CO₂ in the flue gas also results in production of the heat-stable salt. A heat-decomposable amine salt formed resulting from absorption of a volatile acid component, such as hydrogen sulfide and carbonic acid gas, in the flue gas is thermally decomposed by heating it in a regeneration column, and is then discharged as a carbonic acid gas, a hydrogen sulfide gas, etc., by stripping, to regenerate an amine. However, an amine salt combined with a nonvolatile acid component, such as SOₓ, NOₓ, formic acid, acetic acid, oxalic acid, thiocyanic acid, thiosulfuric acid and other inorganic acids, is not decomposed even by heating it in an amine regeneration column, and cannot be separated from the amine solution but accumulates in the amine solution. When the heat-stable salt accumulates as mentioned above, not only the CO₂ absorption efficiency of the amine solution is reduced but also corrosion of the apparatus is caused. Therefore, removal of the heat-stable salt from the amine solution is desired.

As a method for purifying an amine solution by removing the heat-stable salt from the amine solution, purification by distillation is carried out. However, the distillation has a problem that, for example, a huge amount of energy is required or the amine is degraded due to heating during distillation and thereby results in a loss in the yield.

A method using an ion exchange resin is disclosed as a technique for more efficiently removing a heat-stable salt (Patent Document 1). However, in the method of adsorbing a heat-stable salt anion by an ion exchange resin, a regeneration operation needs to be carried out when the resin breaks down. The regeneration operation requires a large amount of a regenerating chemical, and a larger amount of waste is generated from a regeneration solution or a cleaning solution, resulting in an extremely large load on the environment.

A method using electrodialysis is disclosed as a technique for removing a heat-stable salt with a little waste. For example, Patent Document 2 proposes a method where an alkali metal hydroxide is added to a degraded amine solution containing a heat-stable salt to decompose the heat-stable salt and a heat-stable alkali metal salt is removed by electrodialysis to obtain a purified amine. However, the method has a problem of using an alkali chemical, and the environmental load or the load on the apparatus or ion exchange membrane is not negligible.

In Patent Document 3, a method of converting a heat-stable salt to a heat-regenerative salt by electrodialysis with the reflux line containing a heat-regenerative salt ion, such as CO₂, is disclosed as a method not using an alkali metal hydroxide, but there is a problem that a reflux line needs to be separately provided, and an electrodialyzer must have a four-compartment configuration, resulting in a complicated system. Furthermore, a volatile and heat-stable salt component, such as formic acid and acetic acid, may also get mixed in the reflux line, resulting in a problem that amine purification may not sufficiently proceed.

Electrodialysis using a bipolar membrane is well known as a technique for decomposing salts and recovering the corresponding acids by electrodialysis. The technique of using a bipolar membrane for decomposing a heat-stable salt and recovering the corresponding acid may be easily envisaged, but there is a problem, for example, that in practice, a reaction product of an amine contained in an amine solution with CO₂ permeates an ion exchange membrane to cause an amine loss in the yield.

As a method for reducing the amine loss, for example, Patent Document 4 discloses that permeation of a heat-decomposable salt through an ion exchange membrane in the electrodialysis can be suppressed by adjusting the percentage removal of acid to a range from 10 to 50%.

In addition, Patent Document 5 discloses an electrodialyzer having a three-compartment structure consisting of a bipolar membrane and a plurality of anion exchange membranes.

### RELATED ART

### Patent Document

Patent Document 1: Japanese Patent No. 4,831,833

Patent Document 2: Kokoku (Japanese Examined Patent Publication) No. 6-43378

Patent Document 3: Japanese Patent No. 2,779,758

Patent Document 4: Kokai (Japanese Unexamined Patent Publication) No. 2012-130879

Patent Document 5: U.S. Pat. No. 5,194,130

### SUMMARY OF THE INVENTION

### Problems to be Solved by the Invention

However, in the method described in cited Document 4, the concentration of a heat-stable salt in an electrodialyzer is not easily suppressed while operating the electrodialyzer with a low percentage removal of acid. The concentration of a heat-stable salt circulating in the electrodialyzer is desirably kept as low as possible from the standpoint of preventing corrosion of the electrodialyzer, and therefore, it is problematic to set the percentage removal of acid low as in the method described in cited Document 4.

The electrodialyzer described in Patent Document 5 is an apparatus for producing a citrate salt from citric acid and is not intended to regenerate an amine that is a carbon dioxide absorber, and Patent Document 5 does not disclose a mechanism capable of controlling pH in the amine recovery compartment to acidic pH.

In consideration of the above-described problems, an object of the present invention is to provide an apparatus capable of highly purifying an amine solution by efficiently removing a heat-stable salt anion while regenerating an amine and suppressing its loss, and a method for purifying an amine solution by using the apparatus.

### Means to Solve the Problems

In order to attain the above-described object, the present inventors have accomplished the present invention by disposing, in an electrodialyzer, compartments having an amine purification function, an amine recovery function, and an acid recovery function. More specifically, the present invention is as follows.

[1] An electrodialyzer for regenerating an amine, comprising:
a negative electrode;
a positive electrode opposing the negative electrode;
at least one bipolar membrane; and
anion exchange membranes,

wherein one of the at least one bipolar membrane on the negative-electrode side and one of the anion exchange membranes in a position so as to face each other, form a compartment having an amine purification function,

a pair of the anion exchange membranes in which each membrane opposes the other, form a compartment having an amine recovery function,

another of the anion exchange membranes on the negative-electrode side and the positive electrode or another of the at least one bipolar membrane in a position so as to face each other, form a compartment having an acid recovery function, and

between the negative electrode and the positive electrode, the compartment having an amine purification function, the compartment having an amine recovery function and the compartment having an acid recovery function are arranged in a direction from the negative electrode to the positive electrode.

[2] The electrodialyzer according to [1], wherein the compartment having an acid recovery function is formed by another of the anion exchange membranes on the negative-electrode side and another of the at least one bipolar membrane in a position so as to face each other.
[3] The electrodialyzer according to [1] or [2], wherein the electrodialyzer has a three-compartment structure in which an amine purification compartment, an amine recovery compartment and an acid recovery compartment are arranged in this order between the negative electrode and the positive electrode.
[4] The electrodialyzer according to any one of [1] to [3], wherein the amine is a primary amine and/or a secondary amine, and the electrodialyzer further includes a control mechanism for controlling the pH in the compartment having an amine recovery function within the range from 0 to 7.
[5] A method for purifying an amine solution, comprising:

a step of providing the electrodialyzer according to any one of [1] to [4];

a step of introducing the amine solution into the compartment having an amine purification function;

a step of subjecting the amine solution to electrodialysis in the electrodialyzer;

a step of recovering an amine which has permeated at least one of the anion exchange membranes, from the compartment having an amine recovery function; and

a step of removing an acid recovery solution from the compartment having an acid recovery function.

[6] The method according to [5], wherein the amine solution contains a component having a vapor pressure of 0.1 atm or less at 140° C.
[7] The method according to [5] or [6], wherein the amine solution further contains boric acid and/or amino acid.
[8] A carbon dioxide separation/recovery apparatus comprising an absorption column, a regeneration column, and the electrodialyzer according to any one of [1] to [4], wherein

the absorption column has a means for contacting an amine solution with a gas containing carbon dioxide to obtain a carbon dioxide-containing amine solution,

the regeneration column has a means for heating the carbon dioxide-containing amine solution to separate carbon dioxide, and

the electrodialyzer has a means for maintaining a concentration of an acidic component in the amine solution at less than 3.0 mass %.

[9] The apparatus according to [8], further comprising:

a heat exchanger for cooling the amine solution which has been regenerated in the regeneration column; and

a control mechanism for adjusting the concentration of the acidic component in the amine solution removed from the electrodialyzer to less than 50% of the concentration of the acidic component in the amine solution before being introduced into the electrodialyzer.

### Effects of the Invention

According to the present invention, an electrodialyzer comprising a bipolar membrane and first and second anion exchange membranes is used, so that an amine solution can be highly purified by efficiently removing a heat-stable salt anion while regenerating an amine and suppressing its loss.

### BRIEF DESCRIPTION OF THE DRAWINGS

FIG. 1 A flow chart depicting an apparatus or method for regenerating an amine solution in the embodiment of the present invention.

FIG. 2 A schematic view of an apparatus schematically simulating the equipment for carrying out the chemical absorption process in Example 13.

### MODE FOR CARRYING OUT THE INVENTION

The present invention is described in detail below.

In the present invention, the to-be-treated amine solution as a target of purification is an amine solution used for cleaning a gas containing carbonic acid gas, hydrogen sulfide, SOₓ, NOₓ, other acid components, etc., and removing or separating/recovering an acidic gas component. The amine solution is contacted with a gas containing the acidic gas component in an absorption column, and thereby is converted to an amine solution absorbing an acidic component (i.e., rich amine). Thereafter, the rich amine is heated in a regeneration column to decompose a heat-decomposable amine salt, and release/separate the acidic gas component and obtain a regenerated amine solution (i.e., lean amine). The lean amine is the to-be-treated amine solution as a target of purification in the embodiment of the present invention. Purification is carried out by decomposing a heat-stable salt that is not decomposed by heat, and more highly separating an acidic component, whereby the lean amine can stably preserve a cleaning effect over a long period of time.

The amine as a main component of the to-be-treated amine solution is generally an alkanolamine used for absorption of an acidic gas, but the solution may contain other amines.

Specifically, the amine includes:

an amine having one primary amino group, such as monoethanolamine, 2-amino-2-methyl-1-propanol, 3-amino-1-propanol, 1-amino-3-butanol and aniline;

an amine having one secondary amino group, such as 2-methylaminoethanol, 2-ethylaminoethanol, 2-isopropylaminoethanol, diethanolamine, 2-methylaminoisopropanol and 2-ethylaminoisopropanol;

an amine having one tertiary amino group, such as 2-dimethylaminoethanol, 2-diethylaminoethanol, 3-dimethylamino-1-propanol, 4-dimethylamino-1-butanol, 2-dimethylamino-2-methyl-1-propanol, N-ethyl-N-methylethanolamine, methyldiethanolamine, ethyldiethanolamine and triethanolamine;

an amine having two primary amino groups, such as ethylenediamine, hexamethylenediamine and 2-hydroxy-1,3-propanediamine;

an amine having two secondary amino groups, such as N,N′-bis(2-hydroxyethyl)ethylenediamine, N,N′-bis(2-hydroxyethyl)-2-hydroxy-1,3-propanediamine and N,N′-bis(2-hydroxyethyl)hexamethylenediamine;

an amine having two secondary cyclic amino groups, such as piperazine, 2-methylpiperazine and 2,5-dimethylpiperazine;

an amine having a secondary cyclic amino group and a tertiary cyclic amino group, such as 2-hydroxyethylpiperazine;

an amine compound having a plurality of amino groups, such as diethylenetriamine and tetraethylenepentamine; etc.

A liquid containing an amine listed above is usually used in the form of an aqueous solution of 10 to 60 mass %, and may contain a mixture of a plurality of amine types.

The to-be-treated amine solution as a target of purification in the embodiment of the present invention is a lean amine containing the amine recited above, and has a different acid-component content depending on the acidic gas type, the composition, the absorption conditions, the regeneration conditions, etc. In general, the lean amine contains from 0.1 to 20 mass % of a heat-decomposable acid component constituting a heat-decomposable amine salt together with carbonic acid gas, hydrogen sulfide, etc., and contains from 0.01 to 5 mass % of an acid component constituting a heat-stable amine salt together with SOₓ, NOₓ, formic acid, acetic acid, oxalic acid, thiocyanic acid, thiosulfuric acid, etc.

In the embodiment of the present invention, the electrodialyzer is incorporated into a carbon dioxide separation/recovery apparatus, and fulfills a role of purifying an amine by decomposing and removing a heat-stable salt which is generated from the carbon dioxide separation/recovery apparatus and is contained in an amine solution.

In the carbon dioxide recovery apparatus, an amine solution is put into contact with an acidic gas, as a result, a reaction represented by following formula (1) occurs to form a heat-stable salt.

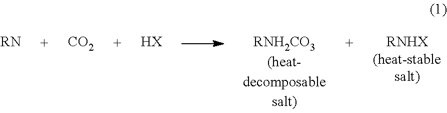

In formula (1), RN represents an amine constituting an amine solution, and X represents an anion component of a heat-stable salt derived from an acidic gas.

In the electrodialyzer, as shown in following formula (2), a heat-stable salt formed in the carbon dioxide recovery apparatus is decomposed, and a purified amine and an acid are recovered.

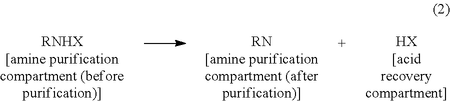

In the carbon dioxide absorption/separation apparatus, the concentration of an acidic component (for example, a heat-stable salt) in the amine solution affects the carbon dioxide absorption efficiency of the amine solution, corrosion of the apparatus, etc., and therefore, is preferably kept at 0 to 3.0 mass %. The concentration is more preferably more than 0 mass % and equal to or not greater than 2.0 mass %. If the concentration of a heat-stable salt exceeds 3.0 mass %, there may be a problem, such as reduction in the carbon dioxide absorption efficiency of the amine solution or corrosion of the apparatus.

In the carbon dioxide absorption/separation apparatus, in order to maintain the concentration of a heat-stable salt in the amine solution within the range described above, when the concentrations of a heat-stable salt before and after a purification treatment by the electrodialyzer are compared, the concentration of a heat-stable salt after treatment is preferably controlled to less than 50%, more preferably less than 30%, still more preferably less than 20%, of the concentration before treatment.

In general, a bipolar electrodialyzer for decomposing a salt and recovering an acid is formed by arranging a bipolar membrane and an anion exchange membrane alternately through a compartment frame, disposing a clamping frame on both ends, and securing the clamp. Accordingly, the bipolar electrodialyzer is formed of a salt compartment compartmentalized by the bipolar membrane and the anion exchange membrane, and an acid recovery compartment; a negative electrode formed at one end of an assembly of the compartments, and a positive electrode formed at the other end thereof; and a power supply system for applying a voltage between the both electrodes. The salt compartment is filled with a to-be-treated solution, the acid recovery compartment is filled with an acid recovery solution, and the negative electrode compartment and positive electrode compartment are filled with an electrode solution. A configuration where a liquid inlet and a liquid outlet are provided in each compartment to enable liquid to be circulated by a pump is also preferred. In this case, the negative electrode compartment solution and the positive electrode compartment solution may be connected. Such a bipolar electrodialyzer specifically includes ACILYZER 02B, 10B, 25B, 50B, EX3B (all trademarks, manufactured by ASTOM Corp.), etc.

In the case of using a bipolar electrodialyzer for removing an acid of a heat-stable salt from an amine solution containing the heat-stable salt, the salt compartment corresponds to an amine purification compartment, and in this compartment, a heat-stable salt anion is removed to purify the amine solution. In the acid recovery compartment of the bipolar electrodialyzer, the acid of the heat-stable salt is recovered.

In the electrodialyzer of the present invention, between a negative electrode and a positive electrode opposing the negative electrode, a compartment having an amine purification function, a compartment having an amine recovery function, and a compartment having an acid recovery function are arranged, in a direction from the negative electrode to the positive electrode.

The compartment having an amine purification function is surrounded by a bipolar membrane disposed on the negative-electrode side and an anion exchange membrane disposed in a position so as to face the bipolar membrane.

The compartment having an amine recovery function is surrounded by a pair of anion exchange membranes in which each membrane opposes the other.

The compartment having an acid recovery function is surrounded by an anion exchange membrane disposed on the negative-electrode side and a positive electrode or bipolar membrane disposed in a position so as to face the anion exchange membrane.

Each of the compartment having an amine purification function, the compartment having an amine recovery function, and the compartment having an acid recovery function may be single or plural as long as the compartments are arranged in the order of “compartment having an amine purification function/compartment having an amine recovery function/compartment having an acid recovery function” in the direction from the negative electrode to the positive electrode, and another compartment may also be disposed between two of the compartments or between any one of the compartments and an electrode.

In addition, as long as the electrodialyzer has an amine purification function, an amine recovery function and an acid recovery function, two or three of the compartment having an amine purification function, the compartment having an amine recovery function and the compartment having an acid recovery function may be integrated as a shared compartment.

In the electrodialyzer, a to-be-treated solution for amine regeneration is preferably treated by passing through respective compartments in the order of “compartment having an amine purification function/compartment having an amine recovery function/compartment having an acid recovery function” in the direction from the negative electrode to the positive electrode.

Specifically, the compartment having an amine purification function may be an amine purification compartment, the compartment having an amine recovery function may be an amine recovery compartment, and the compartment having an acid recovery function may be an acid recovery compartment. The electrodialyzer of the present invention preferably has a three-compartment structure in which the amine purification compartment, the amine recovery compartment and the acid recovery compartment are disposed in this order. It is also preferable that the electrodialyzer of the present invention has a four-compartment structure in which a negative electrode compartment, the amine purification compartment, the amine recovery compartment and the acid recovery compartment are disposed in this order.

For example, with respect to the configuration of a bipolar membrane and two anion exchange membranes, as well as an amine purification compartment, an amine recovery compartment and an acid recovery compartment, each of which is formed of those membranes, only one set of the configuration may be provided between a negative electrode and a positive electrode, or a plurality of sets of the configuration may be provided in series or in parallel.

As the plurality of anion exchange membranes, the same membrane type may be used so long as an anion selectively passes through it, and different membrane types may also be used.

The bipolar membrane is an ion exchange membrane having a structure in which an anion exchange layer and a cation exchange layer are laminated together, and can electrolyze water to produce an acid or an alkali upon application of a voltage not lower than the theoretical decomposition voltage of water.

The cation exchange group of the cation exchange membrane constituting the bipolar membrane is not particularly limited, and may be, for example, a known cation exchange group, such as sulfonic acid group and carboxylic acid group. Among others, in the embodiment of the present invention, taking into account usage of the bipolar membrane, a sulfonic acid group is preferred, since it dissociates as an exchange group even in an acidic atmosphere.

On the other hand, the anion exchange group of the anion exchange membrane constituting the bipolar membrane is not particularly limited, and may be, for example, a known anion exchange group, such as ammonium salt group, pyridinium salt group, primary amino group, secondary amino group and tertiary amino group. Among others, an ammonium salt group is preferred, since it dissociates as an exchange group even in a basic atmosphere.

The bipolar membrane can be produced by various known methods. For example, the production method of a bipolar membrane includes the following methods:

a method where a cation exchange membrane and an anion exchange membrane are laminated together with a polyethyleneimine-epichlorohydrin mixture and adhered by curing the mixture;

a method where a cation exchange membrane and an anion exchange membrane are adhered with an ion exchangeable adhesive;

a method where a cation exchange membrane and an anion exchange membrane are press-bonded across a coated layer of a paste-like mixture of a fine powdery ion exchange resin, an anion or cation exchange resin and a thermoplastic substance;

a method where a surface of a cation exchange membrane is coated with a glue-like substance consisting of vinylpyridine and an epoxy compound, and the coated portion of the glue-like substance is irradiated with radiation;

a method where a sulfonic acid-type polymer electrolyte and allylamines are attached to a surface of an anion exchange membrane, and are then irradiated with ionizing radiation to cause crosslinking;

a method where a mixture containing a dispersion of an ion exchange resin having an opposite electric charge and a matrix polymer is deposited on a surface of an ion exchange membrane;

a method where a sheet-like material obtained by impregnation-polymerizing a polyethylene film with styrene and divinylbenzene is held by a stainless-steel frame, the sheet is removed after one side thereof is sulfonated, and the remaining portion of the sheet is subjected to a chloromethylation treatment and followed by an amination treatment; and

a method where surfaces of an anion exchange membrane and a cation exchange membrane are coated with a specific metal ion, and the both ion exchange membranes are laminated and pressed.

A substrate for the bipolar membrane is determined according to the cation-type exchange membrane or anion-type exchange membrane which is bonded to the substrate. In general, for example, a film, such as polyethylene, polypropylene, polyvinyl chloride, styrene-divinylbenzene copolymer; a net; a knit; a woven fabric; or a nonwoven fabric is used as the substrate. The commercially available bipolar membrane includes NEOSEPTA BP-1E (trademark, produced by ASTOM Corp.).

The anion exchange membrane includes, for example, a membrane obtained by introducing a quaternary ammonium group into a copolymer base film of styrene and divinylbenzene; a membrane in which a quaternary ammonium group is introduced into a styrene-butadiene copolymer base film; a membrane in which styrene is graft-polymerized to a polyethylene film and a quaternary ammonium group is introduced into the graft polymer; and a membrane composed of a copolymerization product of tetraethylene and perfluorovinylethers having a quaternary ammonium group in the side chain. The commercially available anion exchange membrane includes, for example, NEOSEPTA ACM, NEOSEPTA AM-1, NEOSEPTA ACS, NEOSEPTA ACLE-5P, NEOSEPTA AHA, NEOSEPTA AMH, and NEOSEPTA ACS (all trademarks, produced by ASTOM Corp.); SELEMION AMV, SELEMION AMT, SELEMION DSV, SELEMION AAV, SELEMION ASV, SELEMION AHT and SELEMION APS (all trademarks, produced by Asahi Glass Co., Ltd.); FAB and FAA (trademarks, produced by Fumatech GmbH.); and Aciplex A-501, A-231 and A-101 (all trademarks, produced by Asahi Kasei Corp.).

Why leakage of an amine can be suppressed by carrying out electrodialysis using a first anion exchange membrane and a second anion exchange membrane is not only an effect of reducing the final leakage due to the fact that the membrane is merely doubled, but also a surprising effect of suppressing leakage, which is acknowledged. Without being bound by theory, this mechanism is considered as follows. An amine solution after absorbing CO₂ in a combustion flue gas in an absorption column is regenerated by releasing CO₂ in a regeneration column, but the amine is not entirely regenerated in the regeneration column. In order to reduce the CO₂ concentration in the amine solution to substantially 0, strict regeneration conditions are required, and considering the energy efficiency throughout the recovery line, the amine is actually regenerated until a CO₂ content is constant. The remaining CO₂ often forms a carbamate salt in the amine solution (see, following formula (3)). Therefore, at the time of purification of an amine solution by electrodialysis, a carbamate anion permeates the anion exchange membrane, resulting in an amine loss.

RN′H+CO₂→RNCOO⁻+H⁺ (3)

In formula (3), RN′H represents a primary amine or a secondary amine.

On the other hand, in the bipolar electrodialyzer according to the embodiment of the present invention, an amine recovery compartment is formed by a first anion exchange membrane and a second anion exchange membrane, between an amine purification compartment and an acid recovery compartment. Since the carbamate salt is easily decomposed into an amine and CO₂ in an acidic atmosphere, when the amine recovery compartment is in an acidic atmosphere, the amine recovery compartment can decomposes a carbamate anion which has permeated the first anion membrane from the amine purification compartment, and can regenerate the carbamate anion into an amine (see, following formula (4)).

R′NCOO⁻+H⁺→RN′H+CO₂ (4)

The regenerated amine resulting from decomposition of a carbamate anion in the amine recovery compartment does not permeate the second anion membrane because of having no negative electric charge, and therefore, is recovered in the amine recovery compartment without leaking to the neighboring acid recovery compartment. If the amine recovery compartment is not in an acidic atmosphere, the carbamate anion permeates the second anion exchange membrane without being decomposed, and readily gets mixed in an acid recovery solution. A heat-stable salt anion permeates the amine recovery compartment disposed between a first anion exchange membrane and a second anion exchange membrane, but is consumed in the decomposition of a carbamate anion, and accordingly the amine recovery compartment can tend to be alkaline in a continuous operation for a long period of time. Therefore, pH needs to be adjusted so as to maintain an acidic atmosphere. On the other hand, in the case of batch electrodialysis, an acid may be previously added to the amine recovery solution to create an acidic atmosphere. When the acid is added, the electrical resistance of the amine recovery solution decreases to facilitate ion permeation, and thus the electrodialysis time is advantageously shortened. The acid added is not particularly limited if it is a stronger acid than carbonic acid. The acid preferably includes sulfuric acid, nitric acid, acetic acid, formic acid, oxalic acid, etc. As the acid added, an acid recovered from the acid recovery solution of the electrodialyzer of the present invention may also be used.

The pH of the amine recovery solution is preferably from 0 to 7, more preferably from 1 to less than 7, still more preferably from 3 to less than 7. As a mechanism for controlling the pH of the amine recovery compartment within a range from 0 to about 7, for example, a pH monitor, an acid dropwise addition device, etc., may be used individually or in combination. In that case, the pH monitor and the acid dropwise addition device are preferably synchronized in the electrodialyzer. It is also preferable that the electrodialyzer includes a part comprising both of the pH monitor and the acid dropwise addition device.

The above-described effect of preventing amine loss attributable to a carbamate anion is exerted when the amine solution contains a primary amine or a secondary amine. A primary amine or secondary amine is preferred, because these amines exhibit a higher carbon-dioxide absorption rate than a tertiary amine, and are used in many types of amine-solutions.

In the case of using an amine solution containing a high-boiling-point component or a component that is readily decomposed by heat, purification by distillation is difficult. Usually, a component having a vapor pressure of 0.1 atm or less at 140° C. cannot be substantially distilled by steam heating. Even in such a case, purification can be carried out in the bipolar electrodialyzer according to the embodiment of the present invention.

In the case of an amine solution containing a weak acid component or a salt thereof, a weak acid component-derived anion permeates the anion exchange membrane in the purification by an electrodialyzer having only a first anion exchange membrane, and a loss occurs. On the other hand, in the bipolar electrodialyzer of the present invention, the weak acid component-derived anion permeates a first anion exchange membrane, but since the amine recovery compartment is in an acidic atmosphere, dissociation is suppressed and the anion cannot permeate a second anion exchange membrane, so that the amine component can be recovered in the amine recovery compartment. The weak acid component includes, for example, boric acids and amino acids.

The percentage removal (%) of a heat-stable acid component is represented by following formula (5).

Percentage removal (%) of heat-stable acid component=[(concentration of heat-stable acid component in acid recovery solution)×(discharge amount of acid recovery solution)]/[(concentration of heat-stable acid component in to-be-treated amine solution introduced)×(introduction amount of to-be-treated amine solution)]×100 (5)

The percentage leakage (%) and percentage recovery (%) of amine are represented by following formulae (6) and (7), respectively.

Percentage leakage (%) of amine={1−[(concentration of amine in to-be-treated amine solution after electrodialysis)×(amount of to-be-treated amine solution after electrodialysis)]/[(concentration of amine in to-be-treated amine solution introduced)×(introduction amount of to-be-treated amine solution)]}×100 (6)

Percentage recovery (%) of amine={(concentration of amine in amine recovery solution)×(amount of amine recovery solution)}/{[(concentration of amine in to-be-treated amine solution introduced)×(introduction amount of to-be-treated amine solution)]−[(concentration of amine in to-be-treated amine solution after electrodialysis)×(amount of to-be-treated amine solution after electrodialysis)]}×100 (7)

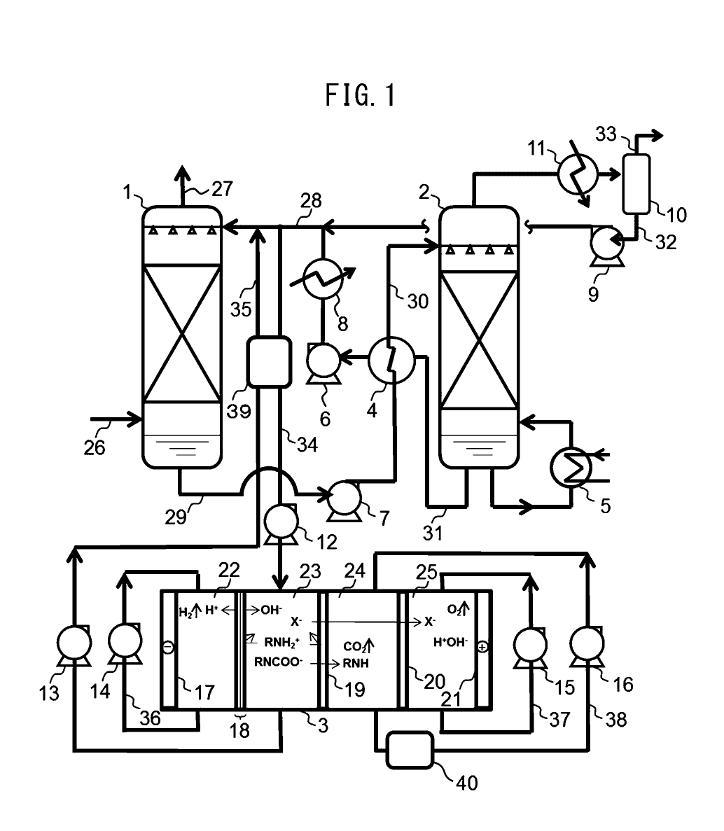

The electrodialyzer as the embodiment of the present invention and the carbon dioxide separation/recovery apparatus using the same are described below by referring to FIG. 1. As shown in FIG. 1, an absorption column 1 is disposed for carrying out a gas treatment step, and the absorption column 1 and a regeneration column 2 are connected by flow paths 28, 29, 30 and 31 through pumps 6 and 7, a heat exchanger 4 and a cooler 8. The absorption column 1 and the regeneration column 2 have a packed bed inside and are configured to carry out absorption and regeneration by gas-liquid contact. In addition, flow paths 26 and 27 are connected to the absorption column 1. The flow path 26 introduces a process gas derived from a petroleum refinery process, a boiler, etc., or an acid component-containing acidic gas, such as flue gas, into the absorption column 1 through a pretreatment apparatus, such as dedusting, denitration or desulfurization apparatus. On the other hand, the flow path 27 is guided to a process, a chimney, etc.

When an acid component-containing acidic gas enters the absorption column 1 from the flow path 26, a lean amine solution entering from the flow path 28 is put into contact with the acidic gas in the packed bed of the absorption column 1, thereby absorbing and removing the acid component, and while the treated gas is discharged to the outside from the flow path 27, the produced rich amine solution can be sent to the regeneration column 2 by the flow path 29.

In the regeneration column 2, a lean amine solution is sent to a reboiler 5, and is heated by steam, thereby thermally decomposing the rich amine solution entering from the flow path 30 to carry out steam stripping, and while a heat-decomposable amine salt, e.g., an amine salt of a volatile acid component, such as carbonic acid gas and hydrogen sulfide, is decomposed to release the volatile acid component, and the amine is regenerated to produce a lean amine solution. The lean amine solution can be circulated to the absorption column 1 from the flow paths 31 and 28, the steam can be condensed by a condenser 10, the condensed water can be flowed back to the absorption column 1 from the flow path 32, and the volatized gas (for example, CO₂) can be discharged from the flow path 33.

As shown in FIG. 1, the electrodialyzer 3 comprises a negative electrode 17, a positive electrode 21, a bipolar membrane 18, a first anion exchange membrane 19, and a second anion exchange membrane 20, and is divided into four regions of a negative electrode compartment 22, an amine purification compartment 23, an amine recovery compartment 24, and an acid recovery compartment 25. As shown in FIG. 1, between the negative electrode 17 and the positive electrode 21, the bipolar membrane 18, the first anion exchange membrane 19 and the second anion exchange membrane 20 are disposed sequentially from the negative electrode 17 to the positive electrode 21, the negative electrode compartment 22 corresponds to the region between the negative electrode 17 and the bipolar membrane 18, the amine purification compartment 23 corresponds to the region between the bipolar membrane 18 and the first anion exchange membrane 19, the amine recovery compartment 24 corresponds to the region between the first anion exchange membrane 19 and the second anion exchange membrane 20, and the acid recovery compartment 25 corresponds to the region between the second anion exchange membrane 20 and the positive electrode 21.

In addition, a to-be-treated amine solution-introducing path 34 is connected to the amine purification compartment 23 so as to introduce a to-be-treated solution to the amine purification compartment 23, a purified amine solution taking-out path 35 is connected to the amine purification compartment 23 so as to remove the purified amine solution from the amine purification compartment 23, an amine recovery solution circulating path 38 is connected to the amine recovery compartment 24 so as to remove the recovered amine from the amine recovery compartment 24, an acid recovery solution-circulating path 37 is connected to the acid recovery compartment 25 so as to remove the acid recovery solution from the acid recovery compartment 25, and a negative electrode compartment solution circulating path 36 is connected to the negative electrode compartment 22 so as to circulate the negative electrode compartment solution.

The to-be-treated amine solution-introducing path 34 is branched from the flow path 28, and a lean amine solution can be guided by a pump 12 to the amine purification compartment 23 of the electrodialyzer 3. On the other hand, the purified amine solution taking-out path 35 is connected to the amine purification compartment 23 and the flow path 28, so that the amine solution which has been purified in the amine purification compartment 23 of the electrodialyzer 3 can be guided to the flow path 28.

The recovered amine solution which has been removed from the amine recovery compartment 24 is circulated by a pump 16 through the amine recovery solution circulating path 38.

The acid recovery compartment 25 serves also as the positive electrode compartment, and therefore, the acid recovery solution is used as a positive electrode compartment solution and is circulated by a pump 15 through the acid recovery solution-circulating path 37.

A regeneration method for an amine solution is also provided by the configuration of the above-described system for regenerating an amine solution. The regeneration method for an amine solution preferably comprises a gas treatment step, an amine regeneration step, and an amine purification step.

The gas treatment step also preferably includes a gas absorption step, an amine solution contact step, and a treated gas-amine solution separation step. In the gas absorption step, an acidic gas can be introduced into the absorption column 1 through the flow path 26. In the amine solution contact step, the acidic gas is put into contact with a lean amine solution entering from the flow path 28 in the packed bed of the absorption column 1, whereby carbonic acid gas, hydrogen sulfide, SOₓ, NOₓ and other acid components can be absorbed and removed. In the treated gas-amine solution separation step, while the treated flue gas is discharged to the outside of the system from the flow path 27, a rich amine solution produced can be sent to the regeneration column 2 from the flow path 29.

In the gas treatment step, not only carbonic acid gas, hydrogen sulfide and other volatile gases, which form a heat-decomposable amine salt, but also a nonvolatile gas, such as SOₓ, NOₓ, formic acid, acetic acid, oxalic acid, thiocyanic acid, thiosulfuric acid and inorganic acid, which form a heat-stale salt are absorbed by the absorption column 1 to form a heat-decomposable amine salt and a heat-stable amine salt.

In the amine regeneration step, the regeneration column 2 is heated by introducing steam generated from the reboiler 5 thereto, whereby the rich amine solution entering the regeneration column 2 from the flow path 30 can be steam-stripped, a heat-decomposable amine salt, such as amine salts of carbonic acid gas and hydrogen sulfide, can be decomposed to release a volatile acid component, the amine can be regenerated to produce a lean amine solution, and the lean amine solution entering from the flow path 31 can be heat-exchanged by the heat exchanger 4, further cooled by the cooler 8, and returned to the absorption column 1. The carbonic acid gas, hydrogen sulfide and other volatile acidic gas, which are decomposed and separated by thermal decomposition, are discharged to the outside of the system from the flow path 33, and the carbonic acid gas is recovered. In the amine regeneration step, a volatile gas, such as carbonic acid gas and hydrogen sulfide, in the amine solution cannot be completely removed, and the volatile gas may partially remain in the amine solution. On the other hand, in the amine regeneration step, a heat-stable salt, for example, an amine salt of a nonvolatile acid component, such as SOₓ, NOₓ, formic acid, acetic acid, oxalic acid, thiocyanic acid, thiosulfuric acid and other inorganic acids, sometimes accumulates in the amine solution without being decomposed.

In the amine purification step, the lean amine solution circulated by the flow path 28 can be partially caused to diverge to the to-be-treated amine solution-introducing path 34, sent to the electrodialyzer 3 and subjected to a purification treatment. The purified amine solution can be returned by a pump 13 to the flow path 28 from the amine purification compartment 23 through the purified amine solution taking-out path 35. The amine which has permeated the first anion exchange membrane 19 can be recovered in the amine recovery compartment 24, and can be removed by the pump 16 from the amine recovery compartment 24 through the recovered amine circulating path 38. The acid recovery solution in the acid recovery compartment 25 can be removed by the pump 15 from the acid recovery compartment 25 through the acid recovery solution-circulating path 37.

In FIG. 1, a flow path for removing the recovered amine solution from the recovered amine solution-circulating path, and a flow path for removing the acid recovery solution from the acid recovery solution-circulating path are omitted.

Accordingly, an amine solution can be purified in the amine purification step.

More specifically, in the amine purification step, an anion dissociated in the to-be-treated amine solution in the amine purification compartment 23, i.e., an acid component (X⁻), is attracted to the positive electrode 21 side by electrodialysis, and therefore, permeates the first anion exchange membrane 19 and the second anion exchange membrane to reach the acid recovery compartment 20. On the other hand, a cation dissociated in the to-be-treated amine solution, i.e., an amine (RNH₂⁺), is attracted to the negative electrode 17 side but is blocked by the bipolar membrane 18, and therefore remains in the amine purification compartment 23. Accordingly, the amine is purified in the state of staying in the amine purification compartment 23 without migrating, and in turn, the amine loss is reduced. However, in the case where a carbamate salt is produced as a reaction product of amine and CO₂, a carbamate anion permeates the anion exchange membrane, resulting in an amine loss. Even when the carbamate anion permeates the first anion exchange membrane, since the amine recovery compartment formed between the first anion exchange membrane and the second anion exchange membrane is in an acidic atmosphere at least during passing of a heat-stable salt anion, the carbamate anion is decomposed and returns to an amine and CO₂. The amine does not permeate the second anion exchange membrane because of having no negative electric charge, and can be recovered in the amine recovery compartment.

In the bipolar membrane 18, hydrogen ion (H⁺) and hydroxyl ion (OH⁻) are produced by electrolysis of water, and the hydrogen ion (H⁺) migrates to the negative electrode compartment 22 to generate a hydrogen gas (H₂), whereas the hydroxyl ion (OH⁻) migrates to the amine purification compartment 23. In the acid recovery compartment (positive electrode compartment) 25, hydrogen ion (H⁺) and an oxygen gas (O₂) are generated by electrolysis of water.

The heat-stable salt concentration in the amine solution which is circulated through the gas treatment step, amine regeneration step and amine purification step is preferably controlled by measuring the concentration of a heat-stable salt anion flowing in the system and the concentration of a heat-stable salt anion in the amine solution after purification.

The heat-stable salt anion concentration may be measured at any step in the process of regenerating an amine solution, and the measurement can be carried out, for example, by a control mechanism 39 shown in FIG. 1. The control mechanism 39 has a function of measuring the heat-stable salt anion concentration and controlling the operating condition of the electrodialyzer according to the measured result of the heat-stable salt anion concentration. The heat-stable salt anion concentration in the system is controlled by measuring the amine solution flowing in the flow path 34 branched from the flow path 28, and the heat-stable salt anion concentration after purification is controlled by measuring the amine solution flowing in the flow path 35. The heat-stable salt anion concentration in the system is preferably from a detection limit concentration to 1%, more preferably from a detection limit concentration to 0.1%, still more preferably from a detection limit concentration to 0.01%. If the heat-stable salt anion concentration in the system exceeds 1%, the CO₂ absorption efficiency of the amine solution may be reduced or corrosion of the apparatus may be caused.

In the embodiment of the present invention, the acidic component concentration (for example, corresponding to the heat-stable salt anion concentration) in the amine solution flowing in the flow path 35 is preferably adjusted to less than about 50% of the acidic component concentration (for example, corresponding to the heat-stable salt anion concentration) in the amine solution flowing in the flow path 34, by means of the bipolar electrodialyzer 3 and the control mechanism 39.

In addition, in the embodiment of the present invention, pH in the amine recovery compartment 24 is preferably controlled within a range from 0 to about 7 by a pH control mechanism 40 including both of a pH monitor and an acid dropwise addition device.

The gas requiring use of the amine solution as a target of purification of the present invention is not particularly limited, and the amine solution can be applied to gases under various concentration, pressure or temperature conditions. Specifically, the gas includes thermoelectric power plant flue gas, iron steel works flue gas, cement plant flue gas, chemical plant flue gas, biofermentation gas, natural gas, etc. Similarly, a carbon dioxide separation/recovery apparatus can be applied to these gases according to the embodiment of the present invention. Among these gases, in the case of gases containing SOₓ and NOₓ, it is more preferable to combine known desulfurization and/or denitration steps with the purification.

### EXAMPLES

The present invention is described in greater detail below based on Examples, but the present invention is not limited to the Examples.

### [Measurement of Concentration of Acids]

An anion concentration was measured by using DX-120 ion chromatograph (manufactured by Dionex Co.) and using, as the column, Ion Pak ASS Guard Column+Ion Pak AS22 for anion analysis, to determine the concentration of acids. An anion standard sample (produced by Wako Pure Chemical Industries, Ltd.) was used as the standard sample.

### [Measurement of Amine Concentration]

The total nitrogen concentration of a sample was measured using TNM-1 total nitrogen analyzer (manufactured by Shimadzu Corporation) and converted to an amine concentration. In the case where the sample contains a nitrate ion, the nitrate ion concentration was measured by DX-120, and a value obtained by subtracting the nitrogen concentration in the nitrate ion from the total nitrogen concentration was employed as the amine concentration.

### [Preparation of Simulated Regeneration Column Distillate Amine Solution I]

CO₂ was blown into 1,500 ml of a 30 mass % aqueous solution of monoethanolamine (MEA) (produced by Wako Pure Chemical Industries, Ltd.) until the pH reaches 10. Next, 500 ml of this solution was added with, as acids of heat-stable salt, acetic acid, formic acid, nitric acid, sulfuric acid and oxalic acid (all produced by Wako Pure Chemical Industries, Ltd.), each in an amount of 1.0 mass % or 0.1 mass %, to prepare two types of Simulated Regeneration Column Distillate Amine Solution I.

### Example 1

With regard to Simulated Regeneration Column Distillate Amine Solution I (500 ml) to which each of the acids has been added in an amount of 1.0 mass %, the acids of heat-stable salt were removed by using an electrodialyzer having a bipolar membrane, a first anion exchange membrane and a second anion exchange membrane (ACILYZER EX3B, manufactured by ASTOM Corp.). Electrodialysis was carried out under the conditions of an effective membrane area of 550 cm², a voltage of 27 V and a temperature of 25° C. by using 500 ml of an aqueous 4% sodium hydroxide solution for the electrode solution, 500 ml of pure water for the amine recovery solution, and 500 ml of 0.1 M sulfuric acid for the acid recovery solution, using NEOSEPTA BP-1E (produced by ASTOM Corp.) as the bipolar membrane and NEOSEPTA AHA (produced by ASTOM Corp.) as the first and second anion exchange membranes, and employing a configuration of (negative electrode compartment) BP-A-A-BP-A-A-BP-A-A-BP-A-A-BP-A-A-BP-A-A-BP-A-A-BP-A-A-BP-A-A-BP-A-A-BP (positive electrode compartment) {wherein BP: bipolar membrane, A: anion exchange membrane} as the membrane configuration. The percentage removal of acids after treatment and the percentage leakage and percentage recovery of MEA are shown in Table 1.

### Example 2

Electrodialysis of 500 ml of Simulated Regeneration Column Distillate Amine Solution I was carried out in the same manner as in Example 1, except that Simulated Regeneration Column Distillate Amine Solution I (500 ml) to which each of the acids has been added in an amount of 0.1 mass % was used. The percentage removal of acids after treatment and the percentage leakage and percentage recovery of MEA are shown in Table 1.

### Example 3

Electrodialysis of 500 ml of Simulated Regeneration Column Distillate Amine Solution I was carried out in the same manner as in Example 1, except that 500 ml of 0.1 M sulfuric acid (produced by Wako Pure Chemical Industries, Ltd.) (pH: 0.7) was used for the amine recovery solution. The percentage removal of acids after treatment and the percentage leakage and percentage recovery of MEA are shown in Table 1.

### Example 4

Electrodialysis of 500 ml of Simulated Regeneration Column Distillate Amine Solution I was carried out in the same manner as in Example 1, except that the pH of the amine recovery solution was monitored and 1 M sulfuric acid was added dropwise to the amine recovery solution to maintain a constant pH of 7. The percentage removal of acids after treatment and the percentage leakage and percentage recovery of MEA are shown in Table 1.

### Comparative Example 1

Electrodialysis of 500 ml of Simulated Regeneration Column Distillate Amine Solution I was carried out in the same manner as in Example 1, except that an electrodialyzer consisting of a bipolar membrane and an anion exchange membrane was used, a configuration of (negative electrode compartment) BP-A-BP-A-BP-A-BP-A-BP-A-BP-A-BP-A-BP-A-BP-A-BP-A-BP (positive electrode compartment) {wherein BP: bipolar membrane, A: anion exchange membrane} was employed as the membrane configuration, and an amine recovery solution was not used. The percentage removal of acids after treatment and the percentage leakage of MEA are shown in Table 1.

### [Preparation of Simulated Regeneration Column Distillate Amine Solution II]

CO₂ was blown into 1,500 ml of a 44 mass % aqueous solution of 2-ethylaminoethanol (EAE) (produced by Wako Pure Chemical Industries, Ltd.) until the pH reaches 10. Next, 500 ml of this solution was added with, as acids of heat-stable salt, acetic acid, formic acid, nitric acid, sulfuric acid and oxalic acid (all produced by Wako Pure Chemical Industries, Ltd.), each in an amount of 1.0 mass % or 0.1 mass %, to prepare two types of Simulated Regeneration Column Distillate Amine Solution II.

### Example 5

Electrodialysis of 500 ml of a simulated regeneration column distillate amine solution was carried out in the same manner as in Example 1, except that Simulated Regeneration Column Distillate Amine Solution II (500 ml) to which each of the acids has been added in an amount of 1.0 mass % was used. The percentage removal of acids after treatment and the percentage leakage and percentage recovery of EAE are shown in Table 1.

### Example 6

Electrodialysis of 500 ml of Simulated Regeneration Column Distillate Amine Solution II was carried out in the same manner as in Example 5, except that Simulated Regeneration Column Distillate Amine Solution II (500 ml) to which each of the acids has been added in an amount of 0.1 mass % was used. The percentage removal of acids after treatment and the percentage leakage and percentage recovery of EAE are shown in Table 1.

### Example 7

Electrodialysis of 500 ml of Simulated Regeneration Column Distillate Amine Solution II was carried out in the same manner as in Example 5, except that Simulated Regeneration Column Distillate Amine Solution II (500 ml) to which each of the acids has been added in an amount of 1.0 mass % was used, and 500 ml of 0.1 M sulfuric acid (produced by Wako Pure Chemical Industries, Ltd.) (pH: 0.7) was used for the amine recovery solution. The percentage removal of acids after treatment and the percentage leakage and percentage recovery of EAE are shown in Table 1.

### Example 8

Electrodialysis of 500 ml of Simulated Regeneration Column Distillate Amine Solution II was carried out in the same manner as in Example 5, except that the pH of the amine recovery solution was monitored and 1 M sulfuric acid was added dropwise to the amine recovery solution to maintain a constant pH of 7. The percentage removal of acids after treatment and the percentage leakage and percentage recovery of EAE are shown in Table 1.

### Comparative Example 2

Electrodialysis of 500 ml of Simulated Regeneration Column Distillate Amine Solution II was carried out in the same manner as in Example 5, except that an electrodialyzer consisting of a bipolar membrane and an anion exchange membrane was used, a configuration of (negative electrode compartment) BP-A-BP-A-BP-A-BP-A-BP-A-BP-A-BP-A-BP-A-BP-A-BP-A-BP (positive electrode compartment) {wherein BP: bipolar membrane, A: anion exchange membrane} was employed as the membrane configuration, and an amine recovery solution was not used. The percentage removal of acids after treatment and the percentage leakage of EAE are shown in Table 1.

### [Preparation of Simulated Regeneration Column Distillate Amine Solution III]

CO₂ was blown into 1,500 ml of an aqueous solution containing 34 mass % of 1,3-bis(2-hydroxyethylamino)propan-2-ol, 9 mass % of piperazine (produced by Wako Pure Chemical Industries, Ltd.) and 2 mass % of boric acid (produced by Wako Pure Chemical Industries, Ltd.) until the pH reaches 10. Next, 500 ml of this solution was added with, as acids of heat-stable salt, acetic acid, formic acid, nitric acid, sulfuric acid and oxalic acid (all produced by Wako Pure Chemical Industries, Ltd.), each in an amount of 1.0 mass % or 0.1 mass %, to prepare two types of Simulated Regeneration Column Distillate Amine Solution III.

### Example 9

Electrodialysis of 500 ml of a simulated regeneration column distillate amine solution was carried out in the same manner as in Example 1, except that Simulated Regeneration Column Distillate Amine Solution III (500 ml) to which each of the acids has been added in an amount of 1.0 mass % was used. The percentage removal of acids after treatment and the percentage leakage and percentage recovery of amine and boric acid are shown in Table 1.

### Example 10

Electrodialysis of 500 ml of a simulated regeneration column distillate amine solution was carried out in the same manner as in Example 9, except that Simulated Regeneration Column Distillate Amine Solution III (500 ml) to which each of the acids has been added in an amount of 0.1 mass % was used. The percentage removal of acids after treatment and the percentage leakage and percentage recovery of amine and boric acid are shown in Table 1.

### Example 11

Electrodialysis of 500 ml of Simulated Regeneration Column Distillate Amine Solution III was carried out in the same manner as in Example 9, except that Simulated Regeneration Column Distillate Amine Solution III (500 ml) to which each of the acids has been added in an amount of 1.0 mass % was used, and 500 ml of 0.1 M sulfuric acid (produced by Wako Pure Chemical Industries, Ltd.) (pH: 0.7) was used for the amine recovery solution. The percentage removal of acids after treatment and the percentage leakage and percentage recovery of amine and boric acid are shown in Table 1.

### Example 12

Electrodialysis of 500 ml of Simulated Regeneration Column Distillate Amine Solution III was carried out in the same manner as in Example 9, except that the pH of the amine recovery solution was monitored and 1 M sulfuric acid was added dropwise to the amine recovery solution to maintain a constant pH of 7. The percentage removal of acids after treatment and the percentage leakage and percentage recovery of amine and boric acid are shown in Table 1.

### Comparative Example 3

Electrodialysis of 500 ml of Simulated Regeneration Column Distillate Amine Solution III was carried out in the same manner as in Example 9, except that an electrodialyzer consisting of a bipolar membrane and an anion exchange membrane was used, a configuration of (negative electrode compartment) BP-A-BP-A-BP-A-BP-A-BP-A-BP-A-BP-A-BP-A-BP-A-BP-A-BP (positive electrode compartment) {wherein BP: bipolar membrane, A: anion exchange membrane} was employed as the membrane configuration, and an amine recovery solution was not used. The percentage removal of acids after treatment and the percentage leakage of amine and boric acid are shown in Table 1.

### Example 13

### Evaluation of Continuous Purification

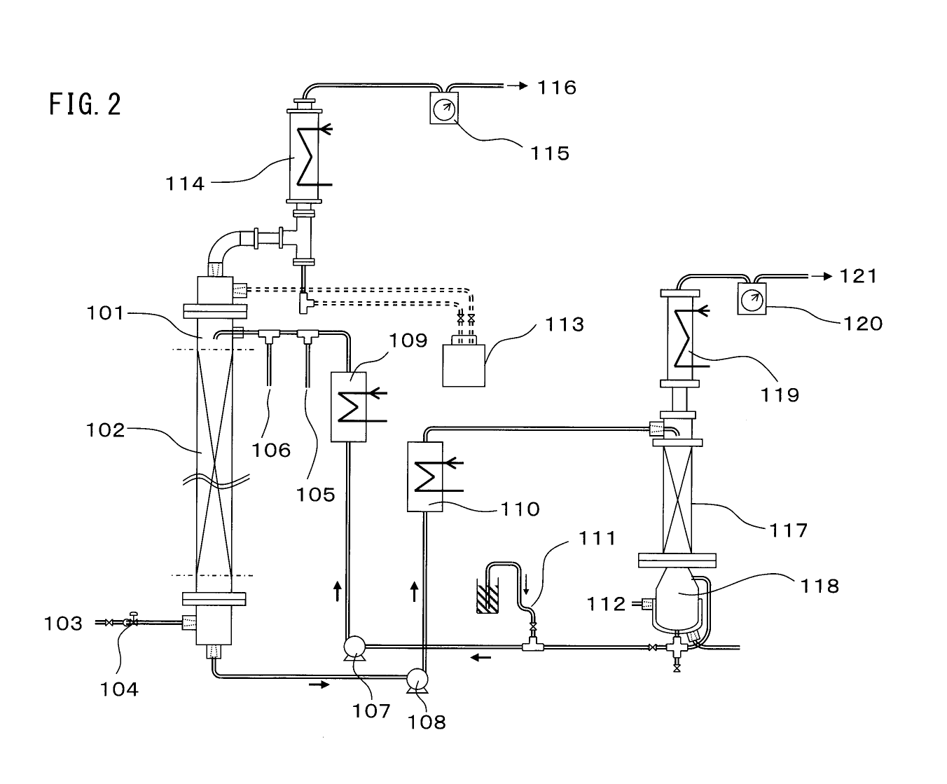

An apparatus shown in FIG. 2 was manufactured and schematically simulates the equipment for carrying out the chemical absorption process, and is used to circulate an amine solution, carrying out actual measurement in the carbon dioxide absorption and release steps, and evaluating the amount of carbon dioxide separated/recovered. In the evaluation method, about 2 L of an amine solution is first supplied into the apparatus from an amine solution supply port 111 and circulated to an absorption column 101 and a regeneration column 117 by amine solution circulating pumps 107 and 108. The amine-solution temperature at the absorption column inlet is adjusted to 30° C. by a heat exchanger 109, and the amine-solution temperature at the regeneration column inlet is adjusted to 90° C. by a heat exchanger 110.

As the absorption column 101, a column made of a vinyl chloride and having a total length of 1,500 mm and an inner diameter of 52 mm is used, and a packed bed 102 in the inside has a height of 1,400 mm and is packed with Dickson Packing (SUS316, 6 mm, specific surface area: 900 m²/m³). In the upper part of the absorption column, a gas is cooled to 15° C. by a condenser 114 to condense water, the condensed water is caused to fall in a condensed water trap 113, and the gas is measured for the flow rate by a gas meter 115 and discharged to an exhaust part 116. As the regeneration column 117, a column made of SUS316 and having a total length of 500 mm and an inner diameter of 55 mm is used and packed inside with Raschig ring (SUS316, φ5 mm). The regeneration column bottom 118 is an SUS316-made vessel having a jacket and is heated by supplying low-pressure steam 112 with adjusted pressure to the jacket such that the amine solution temperature in the bottom is from 102 to 103° C.

The carbon dioxide separated in the regeneration column is cooled to 15° C. by a condenser 119, the condensed water is returned to the regeneration column, and the carbon dioxide gas is measured for the flow rate by a dry gas meter 120 and then discharged to an exhaust part 121. After circulation for about 1 hour until the amine solution temperature is stabilized, a mixed gas having a carbon dioxide concentration of 12 vol % is supplied from a carbon dioxide supply port 103. The mixed gas is supplied into the apparatus from the lower part of the absorption column at 2 m³/hour by using a mass flow controller 104. After supplying the gas, the apparatus is further operated for 1 hour. The apparatus was operated by circulating an amine solution at a flow rate of 100 ml/min by use of a circulating pump 107 for supplying the amine solution to the absorption column.

A reclaimer system of partially extracting the solution from an amine solution branch line 105, purifying the amine solution by an electrodialyzer, and subsequently returning the solution to the original line from an amine solution branch line 106 was established.

The mixed gas was switched to a gas having a carbon dioxide concentration of 12 vol % and containing 230 ppm of SO and 30 ppm of NO, and 1% (flow rate: 60 g/hour) of the absorption solution was extracted from the amine solution branch line 105 by setting the gas flow rate to 2 m²/hour and the amine solution flow rate to 6 kg/hour and purified by an electrodialyzer.

An aqueous solution containing 34 mass % of 1,3-bis(2-hydroxyethylamino)propan-2-ol, 9 mass % of piperazine (produced by Wako Pure Chemical Industries, Ltd.) and 2 mass % of boric acid (produced by Wako Pure Chemical Industries, Ltd.) was used as the amine solution.

With regard to the amine solution extracted from the line, sulfuric acid and nitric acid were removed by using an electrodialyzer (ACILYZER EX3B, manufactured by ASTOM Corp.) having a bipolar membrane, a first anion exchange membrane, and a second anion exchange membrane.

The operation was carried out by using 200 ml of an aqueous 4% sodium hydroxide solution for the electrode solution, using 200 ml of pure water at the start of operation for the amine recovery solution, and during operation, adding dropwise 1 M sulfuric acid to maintain a constant pH of 7 while monitoring the pH. As the acid recovery solution, 500 ml of 0.1 M sulfuric acid was used.

Electrodialysis was carried out under the conditions of an effective membrane area of 55 cm², a voltage of 7.25 V and a temperature of 25° C. by using NEOSEPTA BP-1E (produced by ASTOM Corp.) as the bipolar membrane and NEOSEPTA AHA (produced by ASTOM Corp.) as the first and second anion exchange membranes and employing a configuration of (negative electrode compartment) BP-A-A-BP (positive electrode compartment) {wherein BP: bipolar membrane, A: anion exchange membrane} as the membrane configuration.

The amine solution was fed to the electrodialyzer at 1 ml/min by using a tube pump (Perista Pump SJ-1211H, manufactured by ATTO Corp.). In the amine solution after electrodialysis treatment, the sulfuric acid concentration was 1,000 ppm, and the nitric acid concentration was 640 ppm. This solution was returned to the original line from the amine solution branch line 106, and a continuous operation was carried out, as a result, the concentration of acids in the amine solution of the carbon dioxide separation/recovery apparatus could be kept constant (sulfuric acid: 5,000 ppm, nitric acid: 3,200 ppm) over a long period of time. It can be confirmed from this result that the operation was carried out while maintaining also the carbon dioxide recovery efficiency constant

TABLE 1

| | Percentage Removal of Acids (%) | | | | | Percentage | Percentage | Percentage | Percentage |
|---|---|---|---|---|---|---|---|---|---|
| | Acetic | Formic | Nitric | Sulfuric | Oxalic | Leakage of | Recovery of | Leakage of | Recovery of |
| | Acid | Acid | Acid | Acid | Acid | Amine (%) | Amine (%) | Boric Acid (%) | Boric Acid (%) |
| Example 1 | 88 | 96 | 99 | 91 | 91 | 31 | 100.0 | — | — |
| Example 2 | 91 | 95 | 99 | 92 | 93 | 28 | 99.8 | — | — |
| Example 3 | 90 | 99 | 98 | 95 | 94 | 29 | 99.5 | — | — |
| Example 4 | 91 | 98 | 98 | 96 | 94 | 28 | 99.9 | | |
| Comparative | 93 | 99 | 95 | 98 | 94 | 32 | — | — | — |
| Example 1 | | | | | | | | | |
| Example 5 | 87 | 97 | 99 | 91 | 90 | 20 | 99.7 | — | — |
| Example 6 | 92 | 96 | 99 | 93 | 94 | 19 | 98.0 | — | — |
| Example 7 | 91 | 98 | 97 | 94 | 93 | 21 | 100.0 | — | — |
| Example 8 | 90 | 97 | 98 | 95 | 94 | 22 | 99.6 | | |
| Comparative | 90 | 98 | 96 | 98 | 95 | 22 | — | — | — |
| Example 2 | | | | | | | | | |
| Example 9 | 87 | 97 | 99 | 91 | 90 | 20 | 99.8 | 15 | 86 |
| Example 10 | 92 | 96 | 99 | 93 | 94 | 18 | 98.9 | 13 | 88 |
| Example 11 | 91 | 98 | 97 | 94 | 93 | 22 | 100.0 | 18 | 91 |
| Example 12 | 92 | 98 | 98 | 96 | 94 | 21 | 100.0 | 17 | 95 |
| Comparative | 90 | 98 | 96 | 98 | 95 | 21 | — | 20 | — |
| Example 3 | | | | | | | | | |

In the conventional bipolar electrodialysis, about 20% of amine permeates the anion exchange membrane under the conditions of removing about 90% of acids, and a loss is caused (Comparative Examples 1 to 3), whereas in the bipolar electrodialysis of the present invention, although about 20% of amine similarly permeates the first anion exchange membrane, almost 100% of the permeated amine is recovered in the amine recovery compartment (Examples 1 to 13).

In addition, it can be confirmed from the results of Examples 9 to 12 that even an amine solution containing a high-boiling-point amine component can be purified without any problem, and boric acid as a weak acid component can also be efficiently recovered in the amine recovery compartment.

### INDUSTRIAL APPLICABILITY

The electrodialyzer of the present invention and the purification method using the apparatus can highly purify an amine solution by efficiently removing a heat-stable salt anion while regenerating an amine and suppressing the loss.

### DESCRIPTION OF REFERENCE NUMERALS

1 Absorption column
2 Regeneration column
3 Bipolar electrodialyzer
4 Heat exchanger
5 Reboiler
6,7 Pump
8 Cooler
9 Pump
10 Condenser
11 Cooler
12, 13, 14, 15, 16 Pump
17 Negative electrode
18 Bipolar membrane
19 First anion exchange membrane
20 Second anion exchange membrane
21 Positive electrode
22 Negative electrode compartment
23 Amine purification compartment
24 Amine recovery compartment
25 Acid recovery compartment
26 Flue gas introducing path
27 Treated flue gas exhaust path
28 Lean amine solution introducing path
29 Rich amine solution discharge path
30 Rich amine solution introducing path
31 Lean amine solution discharge path
32 Condenser water flow path
33 CO₂ exhaust path
34 To-be-treated amine solution-introducing path
35 Purified amine solution taking-out path
36 Negative electrode compartment solution circulating path
37 Acid recovery solution-circulating path
38 Amine recovery solution circulating path
39 Control mechanism
40 pH Control mechanism
101 Absorption column
102 Internal packed bed
103 Carbon dioxide supply port
104 Mass flow controller
105 Amine solution branch line
106 Amine solution branch line
107 Amine solution circulating pump
108 Amine solution circulating pump
109 Heat exchanger
110 Heat exchanger
111 Amine solution supply port
112 Low-pressure steam
113 Condensed water trap
114 Condenser
115 Gas meter
116 Exhaust part
117 Regeneration column
118 Regeneration column bottom
119 Condenser
120 Dry gas meter
121 Exhaust part

1. An electrodialyzer for regenerating an amine, comprising:
a negative electrode;
a positive electrode opposing the negative electrode;
at least one bipolar membrane; and
anion exchange membranes,
wherein one of the at least one bipolar membrane on the negative-electrode side and one of the anion exchange membranes in a position so as to face each other, form a compartment having an amine purification function,
a pair of the anion exchange membranes in which each membrane opposes the other, form a compartment having an amine recovery function,
another of the anion exchange membranes on the negative-electrode side and the positive electrode or another of the at least one bipolar membrane in a position so as to face each other, form a compartment having an acid recovery function, and
between the negative electrode and the positive electrode, the compartment having an amine purification function, the compartment having an amine recovery function and the compartment having an acid recovery function are arranged in a direction from the negative electrode to the positive electrode.

2. The electrodialyzer according to claim 1, wherein the compartment having an acid recovery function is formed by another of the anion exchange membranes on the negative-electrode side and another of the at least one bipolar membrane in a position so as to face each other.

3. The electrodialyzer according to claim 1 or 2, wherein the electrodialyzer has a three-compartment structure in which an amine purification compartment, an amine recovery compartment and an acid recovery compartment are arranged in this order between the negative electrode and the positive electrode.

4. The electrodialyzer according to claim 1, wherein the amine is a primary amine and/or a secondary amine, and the electrodialyzer further includes a control mechanism for controlling the pH in the compartment having an amine recovery function within the range from 0 to 7.

5. A method for purifying an amine solution, comprising:
a step of providing the electrodialyzer according to claim 1;
a step of introducing the amine solution into the compartment having an amine purification function;
a step of subjecting the amine solution to electrodialysis in the electrodialyzer;
a step of recovering an amine which has permeated at least one of the anion exchange membranes, from the compartment having an amine recovery function; and
a step of removing an acid recovery solution from the compartment having an acid recovery function.

6. The method according to claim 5, wherein the amine solution contains a component having a vapor pressure of 0.1 atm or less at 140° C.

7. The method according to claim 5 or 6, wherein the amine solution further contains boric acid and/or amino acid.

8. A carbon dioxide separation/recovery apparatus comprising an absorption column, a regeneration column, and the electrodialyzer according to claim 1, wherein
the absorption column has a means for contacting an amine solution with a gas containing carbon dioxide to obtain a carbon dioxide-containing amine solution,
the regeneration column has a means for heating the carbon dioxide-containing amine solution to separate carbon dioxide, and
the electrodialyzer has a means for maintaining a concentration of an acidic component in the amine solution at less than 3.0 mass %.

9. The apparatus according to claim 8, further comprising:
a heat exchanger for cooling the amine solution which has been regenerated in the regeneration column; and
a control mechanism for adjusting the concentration of the acidic component in the amine solution removed from the electrodialyzer to less than 50% of the concentration of the acidic component in the amine solution before being introduced into the electrodialyzer.
